(19) United States
(12) Patent Application Publication
(10) Pub. No.: US 2006/0061127 A1
(43) Pub. Date: Mar. 23, 2006

(54) MOLDED AUTOMOTIVE VISOR

(76) Inventors: David M Emerling, West Bloomfield, MI (US); George B Byma, Clarkston, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/711,457

(22) Filed: Sep. 20, 2004

(51) Int. Cl. B60J 3/00

(52) U.S. Cl. 296/97.1

(57) ABSTRACT

An automotive visor includes a core member and an integrally molded cover layer. The core member may be formed as a single component, or may comprise two sections that are joined together in confronting relationship. The cover layer can be molded to completely encapsulate the core member, or it may be applied to selected areas of the core member. The cover layer is formed from a material having a hardness that is relatively lower than that of the core member, to provide an aesthetically pleasing feel to the finished visor.

### FIELD OF THE INVENTION

The present invention relates generally to visors for automobiles, and more particularly to an integrally molded visor.

### BACKGROUND OF THE INVENTION

Visors have been provided in automobiles to shield occupants' from glaring sunlight which enters the vehicle interior through the windshield or through the side windows. Conventional automotive visors are moveable from a stowed position adjacent the roof or headliner of the automobile, to a downwardly extending position adjacent the windshield to help block the sunlight, as may be desired. Conventional visors are also pivotable from the position adjacent the windshield to a position adjacent a side window, as known in the art.

Conventional methods of manufacturing automotive visors involve forming a core member, generally from plastic or cardboard, and subsequently stretching and wrapping a cover material, such as fabric or leather, over the core member. After the cover material is applied to the core member, it is staked, glued, or otherwise secured to the core member. These conventional methods require multiple components and manufacturing steps which increase the overall cost of producing the visors. In addition, these conventional methods are prone to cause variation in the quality of the finished product. A need therefore exists for an improved automotive visor that overcomes these and other drawbacks of the prior art.

### SUMMARY OF THE INVENTION

The present invention provides an automotive visor and method of manufacture that greatly reduces the time and effort to produce the visor, while at the same time facilitating uniform quality of the produced visors. In one embodiment, the automotive visor includes a core member having an outer surface. A cover layer is integrally molded over the outer surface of the core member, and may either completely encapsulate the core member, or may be applied only to selected areas of the outer surface. In one embodiment, the core member is formed from polymeric material and the cover layer has a hardness that is relatively lower than that of the core member to provide a soft feel that is aesthetically pleasing. In another embodiment, the cover layer may be textured to simulate fabric or leather cover material.

The core member may be formed by various molding methods and may comprise a single unitary piece, or multiple sections that are joined together to form the structural core of the visor. In one particular embodiment, the core member includes first and second sections that are hingedly coupled together and folded toward one another in a confronting arrangement.

In another embodiment, a method of forming an automotive visor includes forming a visor core from polymeric material having a first hardness, integrally molding a cover layer on the outer surface of the core, with the cover layer formed from polymeric material having a hardness relatively lower than the first hardness, and coupling a support arm to the visor core for mounting the visor to an automobile.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an automobile having an exemplary visor, according to the present invention;

FIG. 2A is a perspective view of a first exemplary automotive visor according to the invention;

FIG. 2B is a perspective view of a second exemplary automotive visor according to the invention;

FIG. 3 is a cross-sectional view of a third exemplary visor according to the invention;

FIG. 4 is another cross-sectional view of a fourth exemplary visor according to the invention;

FIG. 5 is an exploded cross-sectional view of a fifth exemplary visor according to the invention; and

FIG. 6 is a cross-sectional view of a sixth exemplary visor according to the invention.

### DETAILED DESCRIPTION

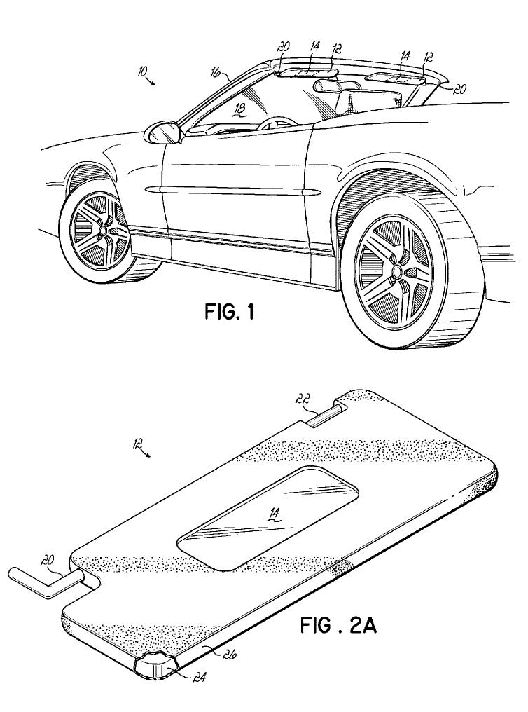

Referring to FIG. 1, an automobile 10 includes sun visors 12 according to the present invention. The sun visors 12 are provided with mirrors 14 and are moveably secured to an upper portion of the vehicle body 16, adjacent the windshield 18. The visors are moveable from a stowed position (depicted in FIG. 1) to a downwardly extending position adjacent windshield 18 by pivoting the visors 12 about a mounting arm 20, as known in the art. Mounting arm 20 also facilitates positioning the visors 12 away from the windshield 18 toward a position adjacent the side windows of the automobile 10, as known in the art.

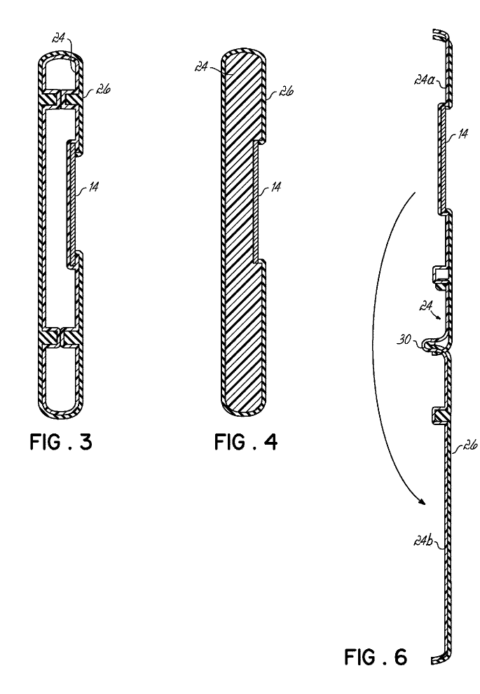

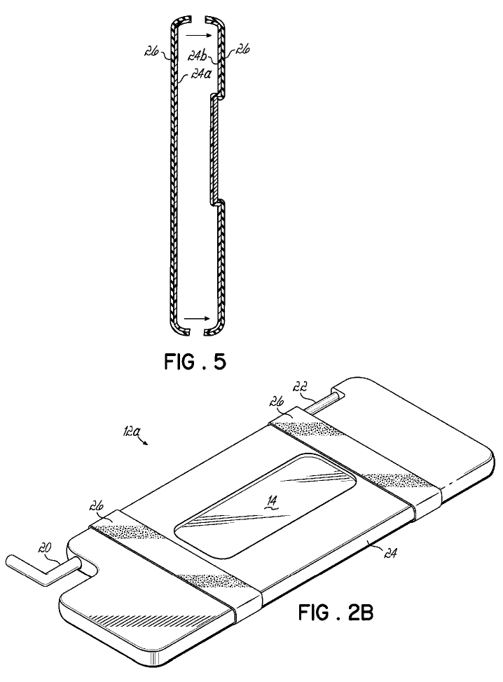

Referring now to FIG. 2A, the visor 12 is shown in greater detail. In the embodiment, shown, the visor further includes a pin or D-ring 22 provided along an edge of the visor 12 to facilitate securing and pivoting the visor 12 from the stowed position to a use position, as known in the art. The visor 12 comprises a core member 24 formed from polymeric material and molded as a generally flat panel to form the structural frame of the visor 12. Alternatively, the core member 24 may be formed from paperboard, foam or other materials.

A cover layer 26 is integrally molded onto the outer surface of the core member 24. When the core member 24 is formed from polymeric material, the material for the cover layer 26 may be selected such that it has a hardness that is relatively lower than the hardness of the core member 24. The lower hardness of the cover layer 26 provides a soft feel to the visor which may be desired to improve the aesthetics of the visor 12. The molded core member 24 may be formed from thermoplastic olefin, (TPO) acrylonitrile butadiene styrene (ABS), styrene maleic anhydride (SMA), polycarbonate/acrylonitrile butadiene styrene alloy (PCABS) or other materials suitable for molding the structural core member 24. The cover layer 26 may comprise vinyl, thermoplastic elastomer (TPE) or other materials for molding the cover layer 26 integrally with the core member 24.

Advantageously, the visor 12 may be formed in a two-shot molding process wherein the core member 24 is formed during a first shot of the molding process, and the cover layer 26 is integrally formed over the core member 24 during the second shot of the molding process. After the cover layer 26 has been molded onto the core member 24, the mounting arm 20 and pin 22 may be coupled to the core member 24 to complete the visor 12. Alternatively, one or more of the mounting arm 20 and pin 22 may be integrally molded with the core member 24.

While FIG. 2A depicts an exemplary visor 12 wherein the cover layer 26 substantially encapsulates the core member 24, the cover layer 26 may alternatively be molded onto the outer surface of the core member 24 in selected areas, as depicted by visor 12a shown in FIG. 2B. In this embodiment, the cover layer 26 is formed onto the core member 24 as a series of stripes or bands. It will be recognized, however, that the cover layer 26 may be formed on the core member 24 in a variety of other patterns or arrangements, as may be desired.

The core member 24 may be molded according to various methods known in the art. For example, the core member 24 may be formed by injection or compression molding to create a single unitary piece, as depicted in FIG. 3. In this embodiment, mirror 14 is integrally molded with the core member 24. It will be recognized, however, that other accessories, such as a remote control for opening a garage door or a slidable supplemental visor shade, for example, may be integrally molded into the visor. The cover layer 26 is subsequently molded over the core member 24, as described above.

FIG. 4 depicts another visor 12 according to the invention wherein the core member 24 is substantially hollow and is formed, for example, by blow molding. Again, the cover layer 26 is molded onto the outer surface of the core member 24, as described above. In this embodiment, however, mirror 14 is integrally molded with and affixed to visor 12 by the cover layer 26, instead of being molded with the core member 24, as described above with respect to FIG. 3. Molding the mirror 14 with cover layer 14 in this manner also facilitates securing the mirror 14 to core member 24 when the core member 24 is formed from paperboard or other non-moldable materials.

FIG. 5 depicts an exemplary visor 12 wherein the core member 24 comprises first and second sections 24a, 24b that are joined together in a confronting arrangement. The first and second sections 24a, 24b may be joined by mechanical interlock such as clips or stakes, by heat sealing the sections, by radio frequency welding, adhesive bonding, or by other methods. When the core member 24 is formed from two sections, the cover layer 26 may be applied to each individual section prior to joining the sections to form the core member, or the sections 24a, 24b may be joined together and the cover layer 26 subsequently applied to the resulting core member 24.

FIG. 6 depicts another exemplary embodiment of a visor according to the invention. In this embodiment, the core member 24 comprises first and second sections 24a, 24b that are hingedly coupled together, such as by a living hinge 30, for example. The core member 24 is formed by folding the first and second sections 24a, 24b about the living hinge 30 and securing them together, as described above. The cover layer 26 may be molded onto and outer surface of the core member 24 prior to folding the first and second sections 24a, 24b about the hinge 30, or it may be applied after the first and second sections have been folded and secured.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. As one example, although polymeric materials are disclosed for use in forming the inventive visor, it will be appreciated that other materials may be used instead or in addition to polymeric materials. Other departures may be made from such details without departing from the scope or spirit of Applicants' general inventive concept.

1. An automotive visor, comprising:
a core member having an outer surface;
a polymeric cover layer integrally molded onto said outer surface of said core member; and
a support arm coupled to said core member and adapted to mount the visor proximate a windshield of an automobile.

2. The visor of claim 1, wherein said core member is formed from polymeric material having a hardness that is relatively higher than a hardness of said cover layer.

3. The visor of claim 1, wherein said core member comprises first and second sections joined together in a confronting arrangement.

4. The visor of claim 3, wherein said first and second sections are hingedly coupled together for folding toward said confronting arrangement.

5. The visor of claim 1, wherein said cover layer substantially encapsulates said core member.

6. The visor of claim 1, wherein said cover layer is integrally molded on selected areas of said outer surface.

7. The visor of claim 1, wherein said cover layer is textured to simulate fabric material.

8. The visor of claim 1, further comprising an accessory affixed to said core member and integrally molded with said cover layer.

9. The visor of claim 8, wherein said accessory is a mirror.

10. A method of forming an automotive visor, comprising:
forming a visor core from a polymeric material having a first hardness;
integrally molding a cover layer on an outer surface of the visor core, the cover layer comprising polymeric material having a second hardness relatively lower than the first hardness; and
coupling a support arm to the visor core, the support arm adapted to mount the visor proximate a windshield of an automobile.

11. The method of claim 10, wherein forming the visor core further comprises:
forming first and second core sections, each core section having an inner surface;
arranging the first and second core sections such that the inner surfaces face one another in a confronting relationship; and
securing the first and second core sections together.

12. The method of claim 10, wherein forming the cover layer further comprises substantially encapsulating the visor core.

13. The method of claim 10, wherein integrally molding the cover layer further comprises applying polymeric material having the second hardness to selected areas of the outer surface.

14. The method of claim 10, further comprising:
integrally molding an accessory onto the visor with the cover layer.

15. The method of claim 14, wherein the accessory comprises a mirror.

16. A method of forming an automotive visor, comprising:
providing a visor core;
integrally molding a polymeric cover layer on an outer surface of the visor core; and
coupling a support arm to the visor core, the support arm adapted to mount the visor proximate a windshield of an automobile.

17. The method of claim 16, further comprising:
integrally molding an accessory onto the visor with the cover layer.

18. The method of claim 17, wherein the accessory comprises a mirror.
